(19) United States
(12) Patent Application Publication
(10) Pub. No.: US 2009/0026957 A1
(43) Pub. Date: Jan. 29, 2009

(54) LED LIGHTING MODULE WITH A HEAT-SINKING FAILSAFE DEVICE

(75) Inventor: Te-Chang CHOU, Hukou Township (TW)

Correspondence Address: EGBERT LAW OFFICES, 412 MAIN STREET, 7TH FLOOR, HOUSTON, TX, 77002, US

(73) Assignee: FORCECON TECHNOLOGY Co., Ltd., Chu Pei City (TW)

(21) Appl. No.: 11/828,249

(22) Filed: Jul. 25, 2007

(51) Int. Cl. H01J 7/44

(52) U.S. Cl. 315/51

(57) ABSTRACT

The present invention provides an LED lighting module with a heat-sinking failsafe device, including LED light sets, a power supply unit and a radiator fan. The radiator fan is linked to a main circuit via a series circuit or a parallel circuit. An electric circuit is placed between the main circuit and radiator fan. A current controller is assembled between the electric circuit and main circuit. When the radiator fan is operated abnormally, the power supply of main circuit could be reduced or interrupted through said electric circuit and current controller. The LED light set is turned into a weak-current state or switched off, thus efficiently preventing overheating or explosion of the LED light set and improving the safety and quality of the LED lighting module.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an LED lighting module, and more particularly to an innovative module which allows the LED to be switched off or turned into in a weak-current state synchronously in the event of failure of a radiator fan.

2. Description of Related Art including Information Disclosed under 37 CFR 1.97 and 37 CFR 1.98

LED lighting modules are widely applied to various lighting and light-emitting products thanks to the advantages of lower power consumption, longer service life and high degree of illumination.

The LED light-emitting components of said LED lighting modules will generate a certain amount of heat once energized, depending upon the quantity configured for LED modules. Moreover, since the LED light-emitting components are assembled onto a single base plate, the temperature not fully dissipated into air is transferred to the base plate, leading to possible overheating damage or even explosion hazards. Thus, forced heat-sinking components are decisive to LED lighting module. Such heat-sinking components are generally implemented through a radiator fan. When an LED lighting module is activated, the radiator fan prevents overheating damage or explosion of the LED lighting module.

To this end, the aforementioned hazards could be resolved through circuit design that allows simultaneous switching-off of the LED and radiator fan. However, the heat-sinking function may still be lost possibly due to jamming of the fan blade by foreign materials or idle operation. In such a case, the LED cannot be switched off simultaneously or respond quickly through circuit design, since the radiator fan is not actually damaged. Also, this situation is hard to recognize from the appearance of the LED lighting module, thus possibly leading to overheating damage or explosion of the LED lighting module.

In light of a variety of LED components for LED lighting modules, a failure-safe system against the damage or malfunction of heat-sinking components is of significance to prevent the hazards arising from widespread LED lighting modules.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The enhanced efficacy of the present invention includes an electric circuit 30 placed between main circuit 20 and radiator fan 12. A current controller (e.g. FET [Field Effect Transistor] 40, 41, transistor 42, 43, relay 44, thyristor 45) is assembled between the first end 31 of said electric circuit 3 and main circuit 20, so that the power supply of main circuit 20 could be reduced or interrupted. The second end 32 of the electric circuit 30 is linked to a detection module 50. The detection module 50 allows the current controller to be activated according to the preset abnormal state of radiator fan 12. As such, the LED light set 10 is turned into a weak-current state or switched off, thus efficiently preventing overheating or explosion of LED light set 10 and improving the safety and quality of the LED lighting module.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows the first schematic view of embodiment of current controller, which is FET for an LED lighting module of the present invention.

FIG. 2 shows the second schematic view of embodiment of current controller, which is FET for an LED lighting module of the present invention.

FIG. 3 shows the third schematic view of embodiment of current controller, which is FET for an LED lighting module of the present invention.

FIG. 4 shows the fourth schematic view of embodiment of current controller, which is FET for an LED lighting module of the present invention.

FIG. 5 shows the first schematic view of embodiment of current controller, which is transistor for an LED lighting module of the present invention.

FIG. 6 shows the second schematic view of embodiment of current controller, which is transistor for an LED lighting module of the present invention.

FIG. 7 shows the third schematic view of embodiment of current controller, which is transistor for an LED lighting module of the present invention.

FIG. 8 shows the fourth schematic view of embodiment of current controller, which is transistor for an LED lighting module of the present invention.

FIG. 9 shows the first schematic view of embodiment of current controller, which is relay for an LED lighting module of the present invention.

FIG. 10 shows the second schematic view of embodiment of current controller, which is relay for an LED lighting module of the present invention.

FIG. 11 shows the first schematic view of embodiment of current controller, which is thyristor for an LED lighting module of the present invention.

FIG. 12 shows the second schematic view of embodiment of current controller, which is thyristor for an LED lighting module of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

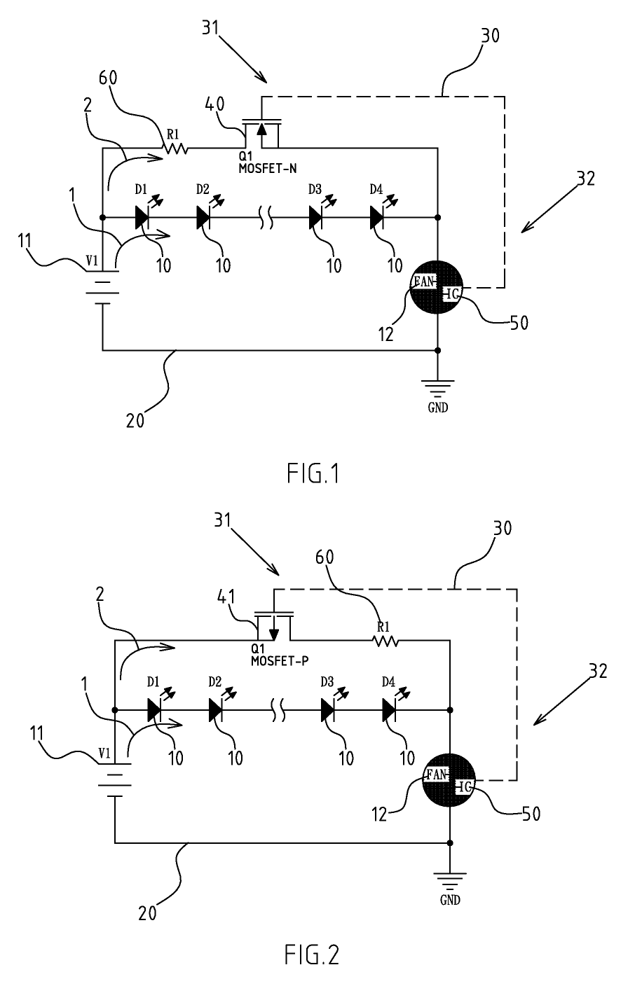

FIGS. 1-12 depict preferred embodiments of the present invention, which, however, are provided for only explanatory purposes. The LED lighting module comprises LED light sets 10, a power supply unit 11 and a radiator fan 12. The LED light sets 10 are linked to power supply unit 11 via a main circuit 20. The radiator fan 12 is linked to main circuit 20 via a series circuit or a parallel circuit.

An electric circuit 30 is placed between the main circuit 20 and radiator fan 12. A current controller is assembled between the first end 31 of said electric circuit 30 and main circuit 20, so that the power supply of main circuit 20 could be reduced or interrupted. The second end 32 of the electric circuit 30 is linked to a detection module 50. The detection module 50 allows the current controller to be activated according to the preset abnormal state of radiator fan 12. The detection module 50, composed of a control IC or a group of control circuits, can be configured internally into or externally onto the radiator fan.

The main circuit 20 is fitted with a pressure-drop component 60, which is composed of resistors or resistance elements (e.g. alarm lights). The resistance of the pressure-drop component 60 is lower than that of LED light set 10.

Said current controller is: FET 40, 41, transistor 42, 43, relay 44, and thyristor 45. The radiator fan 12 is at a preset abnormal state if the rotational speed is detected by the detection module 50 to be zero or lower than a preset speed.

The present invention is operated as follows:

FIG. 1 depicts a series circuit, where the first end 31 of electric circuit 30 is linked to FET 40(MOSFET-N), and the second end 32 is linked to detection module 50.

FIG. 2 depicts a series circuit, where the first end 31 of electric circuit 30 is linked to FET 41(MOSFET-P), and the second end 32 is linked to detection module 50.

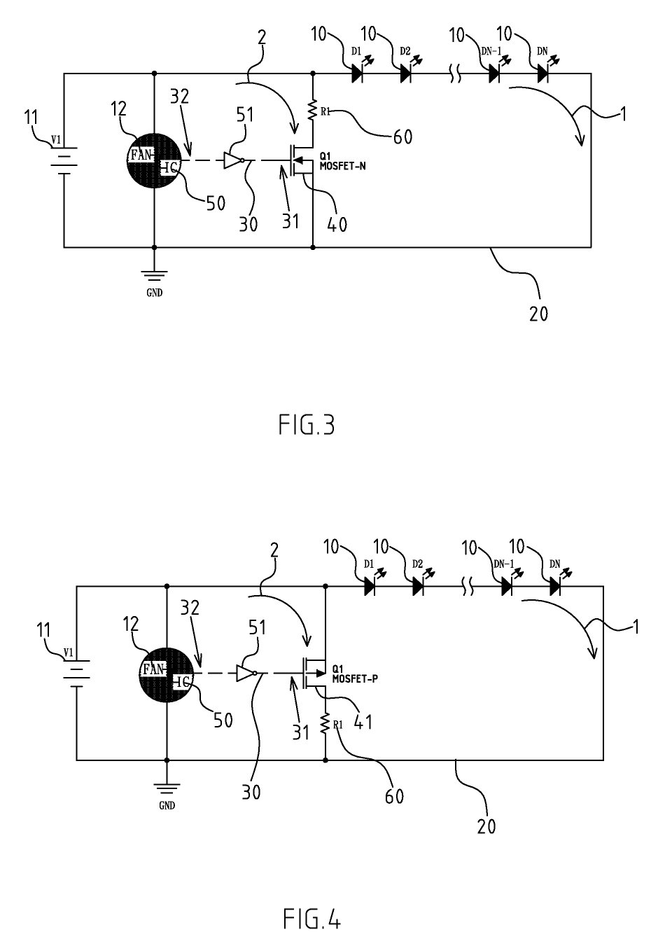

FIG. 3 depicts a parallel circuit, where an inverter 51 is included in the electric circuit 30. The first end 31 is linked to FET 40(MOSFET-N), and the second end 32 is linked to detection module 50.

FIG. 4 depicts a parallel circuit, where an inverter 51 is included in the electric circuit 30. The first end 31 is linked to FET 41(MOSFET-P), and the second end 32 is linked to detection module 50.

FIG. 5 depicts a series circuit, where the first end 31 of electric circuit 30 is linked to transistor 42(NPN), and the second end 32 is linked to detection module 50.

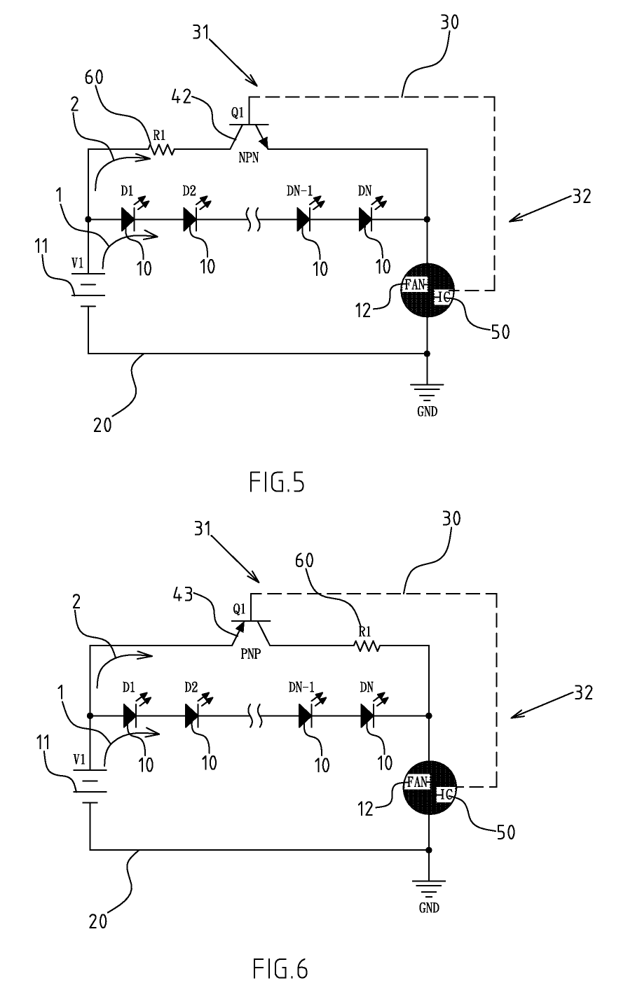

FIG. 6 depicts a series circuit, where the first end of electric circuit 30 is linked to transistor 43(PNP), and the second end 32 is linked to detection module 50.

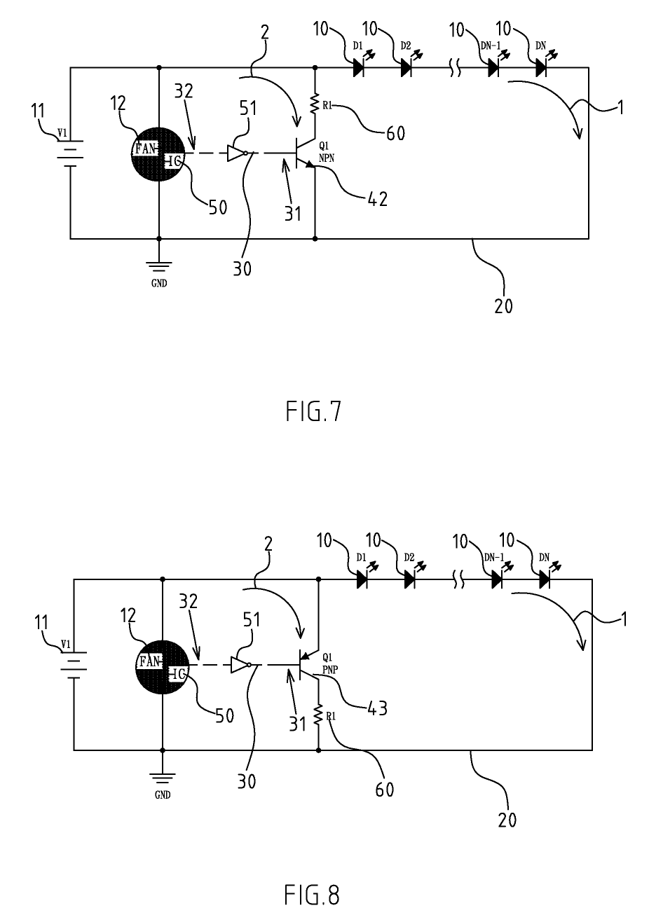

FIG. 7 depicts a parallel circuit, where an inverter 51 is included in the electric circuit 30. The first end 31 is linked to transistor 42(NPN), and the second end 32 is linked to detection module 50.

FIG. 8 depicts a parallel circuit, where an inverter 51 is included in the electric circuit 30. The first end 31 is linked to transistor 43(NPN), and the second end 32 is linked to detection module 50.

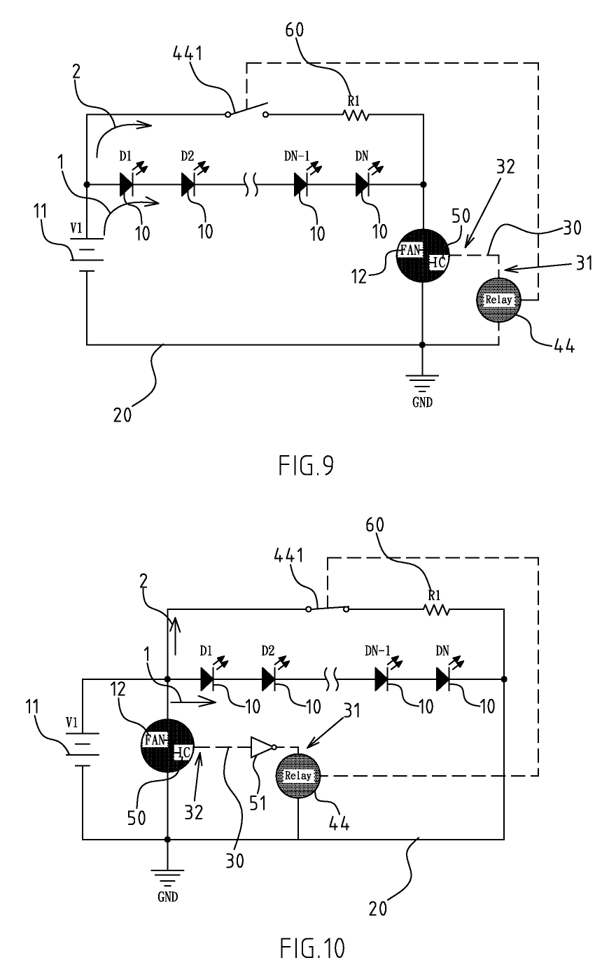

FIG. 9 depicts a series circuit, where the first end 31 of electric circuit 30 is linked to relay 44, and the second end 32 is linked to detection module 50, meanwhile an actuating switch 441 in a normally open state is placed on the main circuit 20.

FIG. 10 depicts a parallel circuit, where an inverter 51 is included in the electric circuit 30. The first end 31 is linked to relay 44, and the second end 32 is linked to detection module 50, meanwhile an actuating switch 441 in a normally close state is placed on the main circuit 20.

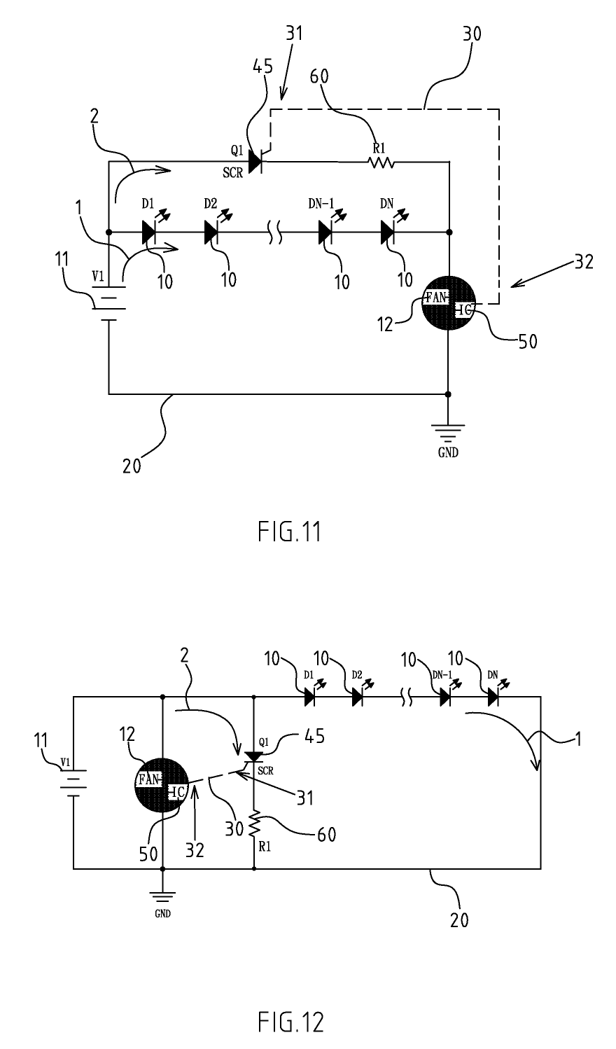

FIG. 11 depicts a series circuit, where the first end 31 of electric circuit 30 is linked to thyristor 45, and the second end 32 is linked to detection module 50.

FIG. 12 depicts a parallel circuit, where an inverter 51 is included in the electric circuit 30. The first end 31 is linked to thyristor 45, and the second end 32 is linked to detection module 50.

The operating principle of the present invention is described below:

Referring to FIGS. 1 and 2, path 1 is a normal circuit, and power supply unit 11 is used to provide a constant voltage source. If the fan 12 is operated slowly or damaged due to jamming by foreign materials, the detection module 50 receives the detection signal from the fan 12, then feeds back via electric circuit 30 to FETs 40, 41 linked to the first end 31 in order to affect the output voltage and maintain a conducting state. In such a case, since the resistance of pressure-drop component 60 on main circuit 20 is lower than that of LED light set 10, most of current will be guided to path 2, so that LED light set 10 linked to main circuit 20 will yield a weak light source or no light source, thus ensuring visualization of any abnormality.

Referring to FIGS. 3 and 4, path 1 is a normal circuit, and power supply unit 11 is used to provide a constant voltage source. If the fan 12 is operated slowly or damaged due to jamming by foreign materials, the detection module 50 receives abnormal signal from fan 12. Then, with the help of inverter 51, the detection module 50 triggers and controls FETs 40, 41 to affect the output voltage to form another path 2. In such a case, since the resistance of pressure-drop component 60 on main circuit 20 is lower than that of LED light set 10, most of the current will be guided to path 2, and a little current guided to path 1, so that LED light set 10 will yield a weak signal or no light source for warning purposes.

Referring to FIGS. 5 and 6, path 1 is a normal circuit, and power supply unit 11 is used to provide a constant voltage source. If the fan 12 is operated slowly or damaged due to jamming by foreign materials, the detection module 50 receives the detection signal from the fan 12, then feeds back via electric circuit 30 to transistors 42, 43 linked to the first end 31 in order to affect the output voltage signal and maintain a conducting state by changing the input current. In such a case, since the resistance of pressure-drop component 60 on main circuit 20 is lower than that of LED light set 10, most current will be guided to path 2, so that LED light set 10 linked to main circuit 20 will yield a weak light source or no light source for warning purposes.

Referring to FIGS. 7 and 8, path 1 is a normal circuit, and power supply unit 11 is used to provide a constant voltage source. If the fan 12 is operated slowly or damaged due to jamming by foreign materials, the detection module 50 receives abnormal signals from fan 12. Then, with the help of inverter 51, the detection module 50 triggers and controls transistors 42, 43 to affect the output voltage signal and to maintain a conducting state by changing the input current. In such a case, since the resistance of pressure-drop component 60 on main circuit 20 is lower than that of LED light set 10, most current will be guided to path 2, and a little current guided to path 1, so that LED light set 10 will yield weak signal or no light source for a warning purpose.

Referring to FIG. 9, path 1 is a normal circuit, and power supply unit 11 is used to provide a constant voltage source. The contact of relay 44 switch 441 is in a normally open state. If the fan 12 is operated slowly or damaged due to jamming by foreign materials, the detection module 50 receives abnormal signals, and then transmits to relay 44 in order to control the relay 44 switch 441 in a conducting state. In such a case, since the resistance of pressure-drop component 60 on main circuit 20 is lower than that of LED light set 10, most current will be guided to path 2, and a little current guided to path 1, so that LED light set 10 will yield a weak signal or no light source for a warning purpose.

Referring to FIG. 10, power supply unit 11 is used to provide a constant voltage source. If the fan is normally activated, the detection module 50 receives a normal signal from fan 12, and inverter 51 is used to trigger the relay 44 in order to control the contact of switch 441 in an open state (namely, path 2 is not conducted, so path 1 is a normal circuit). If the fan 12 is operated slowly or damaged due to jamming by foreign materials, the detection module 50 receives abnormal signals from fan 12, and then triggers relay 44 via inverter 51 in order to control the switch 441 in a conducting state. In such a case, since the resistance of pressure-drop component 60 on main circuit 20 is lower than that of LED light set 10, most current will be guided to path 2, and a little current guided to path 1, so that LED light set 10 will yield a weak signal or no light source for a warning purpose.

Referring to FIG. 11, path 1 is a normal circuit, and power supply unit 11 is used to provide a constant voltage source. If the fan 12 is operated slowly or damaged due to jamming by foreign materials, the detection module 50 receives the detection signal from the fan 12, then feeds back via electric circuit 30 to thyristor 45 linked to the first end 31 in order to trigger and maintain a conducting state. In such a case, since the resistance of pressure-drop component 60 on main circuit 20 is lower than that of LED light set 10, most current will be guided to path 2, and a little current guided to path 1, so that LED light set 10 will yield a weak signal or no light source for a warning purpose.

Referring to FIG. 12, path 1 is a normal circuit, and power supply unit 11 is used to provide a constant voltage source. If the fan 12 is operated slowly or damaged due to jamming by foreign materials, the detection module 50 receives an abnormal signal from fan 12 and then triggers thyristor 45 to form a power supply path 2. In such a case, since the resistance of pressure-drop component 60 on main circuit 20 is lower than that of LED light set 10, most current will be guided to path 2, and a little current guided to path 1, so that LED light set 10 will yield a weak signal or no light source for a warning purpose.

Additionally, said power supply unit 11 is also available with a constant current output mode.

1-8. (canceled)

9. A heat-sinking failuresafe device comprising:
an LED light set having a resistance;
a power supply unit linked to said LED light set by a main circuit;
a radiator fan linked to said main circuit by another circuit, said another circuit being one of a series circuit and a parallel circuit;
an electric circuit connecting said main circuit and said radiator fan;
a current controlling means electrically connected between a first end of said electric circuit and said main circuit, said current controlling means for reducing or interrupting said power supply; and
a detecting means electrically connected to a second end of said electric circuit, said detecting means for activating said current controlling means when a preset abnormal state of said radiator fan is detected by said detecting means, said main circuit having a resistor thereon having a resistance less than said resistance of said LED light set.

10. The heat-sinking failuresafe device of claim 9, said current controlling means being a controller selected from the group consisting of a field-effect transistor, a transistor, a relay and a thyristor.

11. The heat-sinking failuresafe device of claim 9, said preset abnormal state being a rotational speed of said radiator fan that is less than a preset rotational speed.

12. The heat-sinking failuresafe device of claim 9, said detecting means being a control IC.

13. The heat-sinking failuresafe device of claim 9, said detecting means being built into said radiator fan.

14. The heat-sinking failuresafe device of claim 9, said detecting means being affixed to an exterior of said radiator fan.

15. The heat-sinking failuresafe device of claim 9, said power supply unit being a constant voltage source.

16. The heat-sinking failuresafe device of claim 9, said power supply unit being a constant current source.
